(19) United States
(12) Patent Application Publication
(10) Pub. No.: US 2026/0342501 A1
(43) Pub. Date: Oct. 29, 2026

(54) METHOD AND APPARATUS FOR UPLINK CONTROL INFORMATION TRANSMISSION IN MOBILE COMMUNICATIONS

(71) Applicant: MEDIATEK INC., Hsinchu City (TW)

(72) Inventors: Yi-Ju LIAO, Hsinchu City (TW); Pei-Kai LIAO, Hsinchu City (TW); Chi-Hsuan HSIEH, Hsinchu City (TW)

(73) Assignee: MEDIATEK INC., Hsinchu City (TW)

(21) Appl. No.: 19/473,784

(22) PCT Filed: Oct. 23, 2024
(86) PCT No.: PCT/CN2024/126624

§ 371 Date: Oct. 8, 2025

Related U.S. Application Data
(60) Provisional application No. 63/594,452, filed on Oct. 31, 2023.
(60) Provisional application No. 63/627,167, filed on Jan. 31, 2024.

(51) Int. Cl. H04L 5/00; H04B 7/06

(52) U.S. Cl. CPC H04L 5/0044; H04B 7/0626; H04L 5/0007; H04L 5/0055

(57) ABSTRACT

Various solutions for determining an uplink control information (UCI) transmission with respect to an apparatus in mobile communications are described. The apparatus may transmit a downlink control information (DCI). The DCI may indicate a physical uplink shared channel (PUSCH) used for UCI transmission. The apparatus may receive the PUSCH including a UCI.

### CROSS REFERENCE TO RELATED PATENT APPLICATION(S)

The present disclosure is part of a non-provisional application claiming the priority benefit of U.S. Patent Application No. 63/594,452, filed 31 Oct. 2023 and U.S. Patent Application No. 63/627,167, filed on 31 Jan. 2024, the contents of which herein being incorporated by reference in their entirety.

### TECHNICAL FIELD

The present disclosure is generally related to mobile communications and, more particularly, to uplink control information (UCI) transmission with respect to apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR) mobile communications, downlink control information (DCI) may include scheduling information for user equipment (UE) to receive or transmit data via scheduled network resources. More specially, based on a downlink (DL) DCI, the UE may receive a physical downlink shared channel (PDSCH) from the network node after k0 slot(s) which is (are) configured between the DL DCI and the PDSCH, and transmit a physical uplink control channel (PUCCH) (e.g., a PUCCH including HARQ-ACK) to the network node after k1 slot(s) which is (are) configured between the PDSCH and the PUCCH. Furthermore, based on an uplink (UL) DCI, the UE may transmit physical uplink shared channel (PUSCH) to the network node after k2 slot(s) which is (are) configured between the UL DCI and the PUSCH. In addition, from decoding the DL DCI to being ready to receive the PDSCH, N1 symbols represent the required time. From receiving an UL DCI to preparing the PUSCH transmission, N2 symbols represent the required time, which is used to ensure that the UE may have sufficient time to prepare the PUSCH transmission. These time related factors may refer to hard real-time (HRT) which is time critical.

In some network scenarios, some transmission determinations (i.e., arbitrations) affecting the implementation for HRT may be performed by the UE. For example, when preparing a PUCCH carrying HARQ-ACK information, the UE determines PUCCH format based on HARQ-ACK codebook size. Furthermore, when PUCCH, including HARQ-ACK information, is scheduled to be overlapped with PUSCH, the UE determines to piggyback HARQ-ACK information on PUSCH. Additionally, based on HARQ-ACK bit number, the UE determines whether puncturing or rate-matching is used. Therefore, the uncertainty on HARQ codebook size and uplink channel multiplexing increase UE implementation complexity, making the implementation of HRT even more critical.

Accordingly, reducing HRT-related transmission determinations performed by the UE becomes an important issue in the newly developed wireless communication network. Therefore, there is a need to provide proper schemes to reduce HRT-related transmission determinations performed by the UE.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to uplink control information (UCI) transmission with respect to apparatus in mobile communications.

In one aspect, a method may involve an apparatus transmitting a downlink control information (DCI). The DCI may indicate a physical uplink shared channel (PUSCH) used for UCI transmission. The method may further involve the apparatus receiving the PUSCH including a UCI.

In one aspect, a method may involve an apparatus receiving a DCI. The DCI may indicate a PUSCH used for UCI transmission. The method may further involve the apparatus transmitting the PUSCH including a UCI.

In one aspect, an apparatus may comprise a transceiver which, during operation, wirelessly communicates with a wireless network. The apparatus may also comprise a processor communicatively coupled to the transceiver. The processor, during operation, may perform operations comprising transmitting, via the transceiver, a DCI. The DCI may indicate a PUSCH used for UCI transmission. The processor may further perform operations comprising receiving, via the transceiver, the PUSCH including a UCI.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example scenario under schemes in accordance with implementations of the present disclosure.

FIG. 8 is a block diagram of an example communication system in accordance with an implementation of the present disclosure.

FIG. 9 is a flowchart of an example process in accordance with an implementation of the present disclosure.

FIG. 10 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to uplink control information (UCI) transmission with respect to apparatus in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may determine (i.e., schedule) a physical uplink shared channel (PUSCH) used for UCI transmission. Then, the network node may transmit a DCI to a user equipment (UE). The DCI may indicate the PUSCH. After receiving the DCI, the UE may transmit the PUSCH including a UCI based on the DCI. Accordingly, because the UE may transmit the UCI via the PUSCH scheduled by the network node, the UE may not need to perform some transmission determinations (i.e., arbitrations) which may increase UE implementation complexity, making the implementation of HRT more flexible.

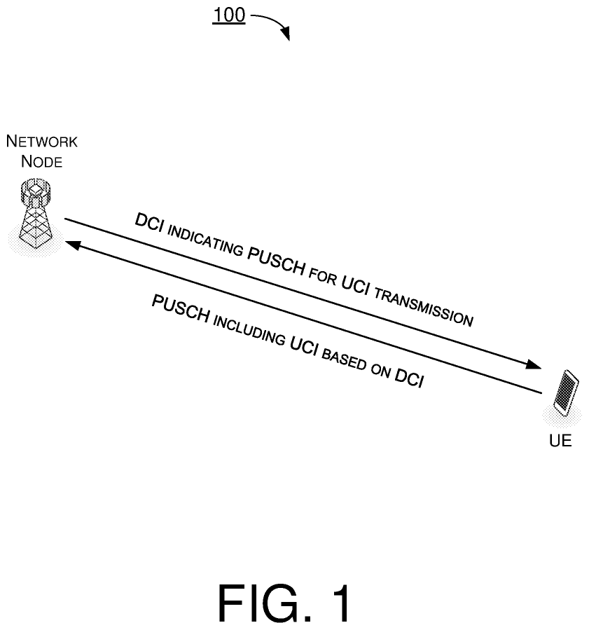

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes.

In some embodiments, the network node may determine (i.e., schedule) a PUSCH used for UCI transmission (e.g., PUSCH dedicated for carrying UCI). Then, the network node may transmit a DCI (e.g., an uplink (UL) DCI including UL-grant) to the UE. The DCI may indicate the PUSCH used for UCI transmission. After receiving the DCI, the UE may transmit the PUSCH including a UCI based on the DCI. The UCI may be a hybrid automatic repeat request-acknowledgment (HARQ-ACK) codebook and/or a channel state information (CSI) report.

Accordingly, because the network node may schedule the PUSCH for carrying UCI and indicate the PUSCH to the UE via the DCI, the UE may transmit the UCI via the PUSCH based on the DCI without performing some transmission determinations (i.e., arbitrations). In other words, the network node may take the full responsibility of transmission arbitrations and schedules, and the UE may simply follow the network node scheduling PUSCH for UCI transmission. Therefore, UE implementation complexity may be reduced, and the implementation of HRT may be more flexible.

In some implementations, in an event that the UCI includes HARQ-ACK codebook, the UCI may be transmitted in a single PUSCH on primary cell (PCell). In some implementations, in an event that the UCI includes CSI report, the UCI may be transmitted in a single PUSCH on PCell.

In some implementations, a payload size associated with the UCI may be indicated by the DCI or by a higher layer signaling (e.g., radio resource control (RRC) singling). In some cases, the payload size associated with the UCI (e.g., HARQ-ACK codebook size of HARQ-ACK codebook) may be directly indicated by the DCI at the beginning of a configured period (e.g., time division duplex (TDD) and may not be changed during the period. In some cases, a set of the payload sizes associated with the UCI (e.g., HARQ-ACK codebook size of HARQ-ACK codebook) may be configured by the network node via UE-specific RRC signaling. Then, the DCI may indicate which entry is selected from the set. In some cases, when there are multiple HARQ-ACK codebooks to be feedback, the determined payload sizes may be signaled separately or jointly.

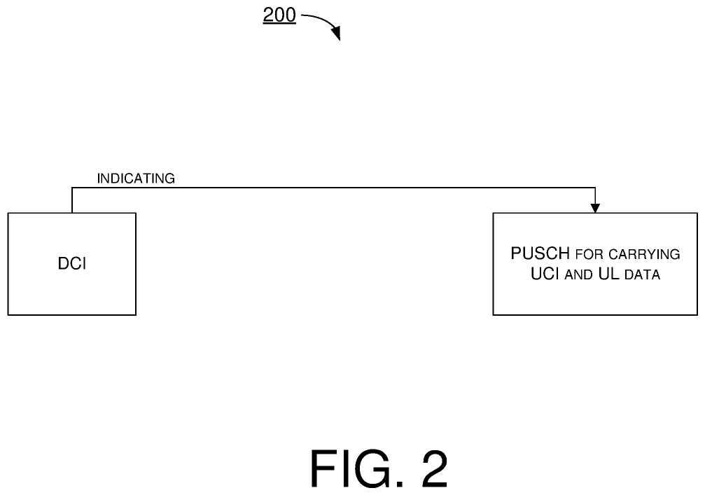

FIG. 2 illustrates an example scenario 200 under schemes in accordance with implementations of the present disclosure. In some implementations, the DCI may indicate that the scheduled PUSCH carries an UL data. In particular, the DCI (e.g., normal DCI, 2^{nd} DCI of two-stage DCI, multi-DCI (mDCI), etc.) may indicate the PUSCH used for carrying UCI and UL data (i.e., UL-SCH).

In some implementations, in an event that the PUSCH carries the UL data, the UE may encode the UCI and the UL data of the PUSCH separately and transmit the PUSCH to the network node. After receiving the PUSCH, the network node may decode the UCI and the UL data of the PUSCH separately.

In some implementations, in an event that the PUSCH includes the UL data, the UE may map the UCI and the UL data to a plurality of resource elements (REs) of the PUSCH from a specific RE of the PUSCH. More specifically, the UCI and the UL data may be mapped in order to the plurality of REs which may exclude at least one RE for demodulation reference signal (DMRS) (i.e., the RE(s) for DMRS may not be counted as the plurality of REs for mapping UCI and UL data). The specific RE may be within a first available orthogonal frequency-division multiplexing (OFDM) symbol and may have lowest RE index. In some cases, when the UCI includes both a HARQ-ACK codebook and a CSI report, the HARQ-ACK codebook and a CSI report may be mapped in order to the plurality of REs. Accordingly, the mapping priority for UCI and UL data to the available REs may be: first, the HARQ-ACK codebook (if present); second, the CSI report (if present); and finally, the UL data (if present).

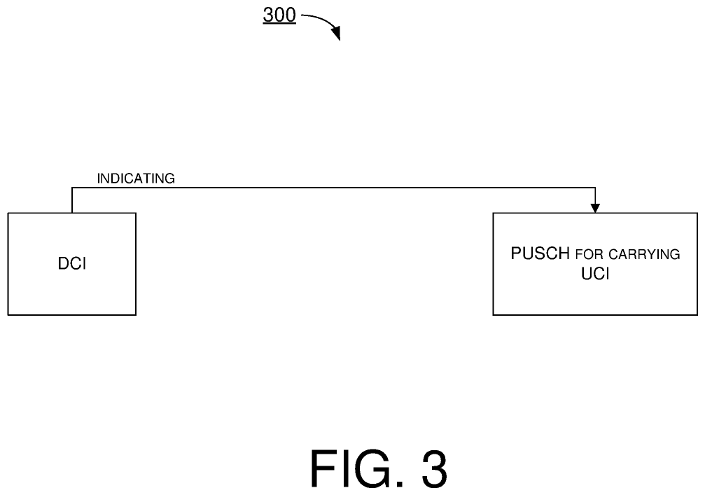

FIG. 3 illustrates an example scenario 300 under schemes in accordance with implementations of the present disclosure. In some implementations, the DCI may indicate that the scheduled PUSCH excludes any UL data. In particular, the DCI (e.g., normal DCI, 2^{nd} DCI of two-stage DCI, multi-DCI (mDCI), etc.) may indicate the PUSCH used for carrying UCI without any UL data (i.e., UL-SCH).

In some implementations, in an event that the PUSCH excludes any UL data, the UE may map the UCI to a plurality of REs of the PUSCH from a specific RE of the PUSCH. More specifically, the UCI may be mapped to the plurality of REs which may exclude at least one RE for DMRS. The specific RE may be within a first available OFDM symbol and may have lowest RE index. In some cases, when the UCI includes both a HARQ-ACK codebook and a CSI report, the HARQ-ACK codebook and a CSI report may be mapped in order to the plurality of REs. Accordingly, the mapping priority for UCI to the available REs may be: first, the HARQ-ACK codebook (if present); and second, the CSI report (if present).

In some implementations, configuration(s) of the last received DCI may be applied for scheduling UCI. In particular, a series of associated DCIs may be transmitted over a given period. Each DCI may indicate a PUSCH used for carrying UCI. The UE may apply configuration(s) of the last received DCI (e.g., UL-grant of the last received DCI) for scheduling the PUSCH carrying the UCI.

In some implementations, a first DCI may indicate a PUSCH used for carrying UCI without any UL data. After receiving the first DCI, the UE may apply configuration(s) of the first DCI for scheduling UCI. Then, a second DCI may indicate a PUSCH used for carrying UCI and UL data. After receiving the second DCI, the UE may apply configuration(s) of the second DCI for scheduling UCI. In other words, the UCI scheduling configuration(s) of the first DCI indicating the PUSCH used for carrying UCI without any UL data may be overridden by corresponding UCI scheduling configuration(s) of the second DCI indicating the PUSCH used for carrying UCI and UL data. More specifically, the UCI scheduling configuration(s) of the second DCI indicating the PUSCH used for carrying UCI and UL data may have higher priority than the first DCI indicating the PUSCH used for carrying UCI without UL data.

In some cases, the UCI scheduling configuration(s) of the first DCI indicating the PUSCH used for carrying UCI without any UL data may be overridden by corresponding UCI scheduling configuration(s) of the second DCI indicating the PUSCH used for carrying UCI and UL data when the first DCI and the second DCI are scheduled in a configured period. In some cases, the UCI scheduling configuration(s) of the first DCI indicating the PUSCH used for carrying UCI without any UL data may be overridden by corresponding UCI scheduling configuration(s) of the second DCI indicating the PUSCH used for carrying UCI and UL data when the first DCI and the second DCI indicate to feedback the same HARQ-ACK group and/or the same CSI report. In some cases, UCI scheduling configuration(s) of the second DCI indicating the PUSCH used for carrying UCI and UL data may not be overridden.

In some implementations, the configuration(s) of the DCI for scheduling UCI (i.e., UCI scheduling configuration(s) of the DCI) may include at least one of: (1) time allocation; (2) frequency allocation; (3) multi-input multi-output (MIMO) layer number; (4) modulation order; and (5) frequency hopping information.

In some implementations, a HARQ-ACK group index may be introduced to enable flexible bundling of HARQ-ACK bit. In particular, the DCI indicating PUSCH used for HARQ-ACK codebook may include a HARQ-ACK group index associated with a HARQ-ACK codebook including at least one HARQ-ACK information. More specifically, HARQ-ACK(s) having the same HARQ-ACK group index may be bundled to the same UCI (e.g., HARQ-ACK codebook) which is indicated by the DCI including the HARQ-ACK group index. The UE may transmit the HARQ-ACK codebook associated with the HARQ-ACK group index in the UCI.

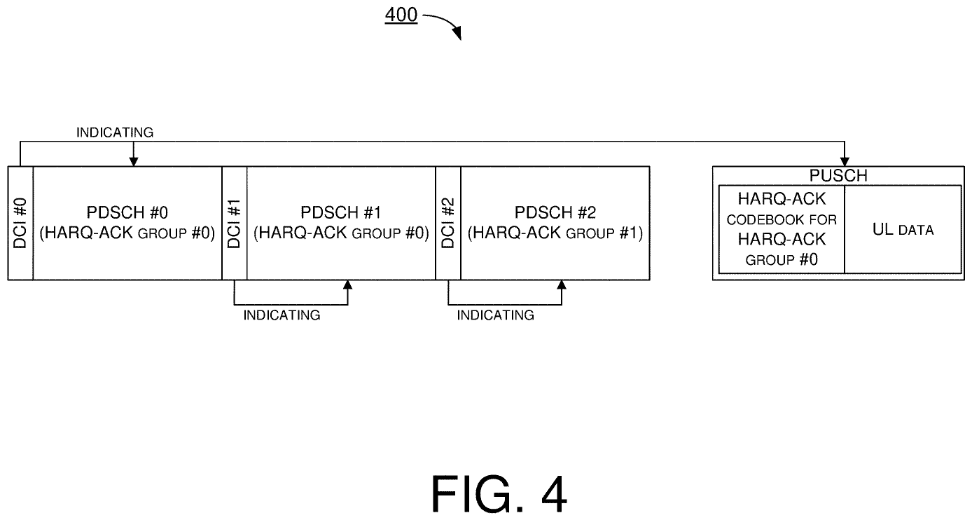

FIG. 4 illustrates an example scenario 400 under schemes in accordance with implementations of the present disclosure. For example, when scheduling physical downlink shared channel (PDSCH)(s), the network node assigns which HARQ group to which the PDSCH belongs via DCI. In this example, DCI #0 includes HARQ-ACK group index #0 and indicates: (1) PDSCH #0 belonging to HARQ-ACK group #0; and (2) PUSCH used for carrying UCI and UL data. DCI #1 indicates PDSCH #1 belonging to HARQ-ACK group #0. DCI #2 indicates PDSCH #2 belonging to HARQ-ACK group #1. Accordingly, generated HARQ-ACKs for PDSCHs #0 and #1 belonging to the same HARQ-ACK group #0 are bundled to the same HARQ-ACK codebook which is indicated by DCI #0 including the HARQ-ACK group index #0. In addition, generated HARQ-ACK for PDSCHs #2 belonging to the different HARQ-ACK group #1 is not bundled to the HARQ-ACK codebook which is indicated by DCI #0 including the HARQ-ACK group index #0. The UE transmits the HARQ-ACK codebook associated with the HARQ-ACK group index #0 in the UCI of the PUSCH.

In some implementations, in an event that UCI is transmitted by a PUSCH without UL data, a payload size of the UCI may be derived based on at least one or a set of the following fields in the corresponding DCI: (1) modulation and coding scheme (MCS); (2) MIMO layer number; and (3) number of available resource elements obtained from time and frequency allocation. In some cases, when the UCI includes both HARQ-ACK codebook and CSI report, the HARQ-ACK codebook and the CSI report may have separate coding chains.

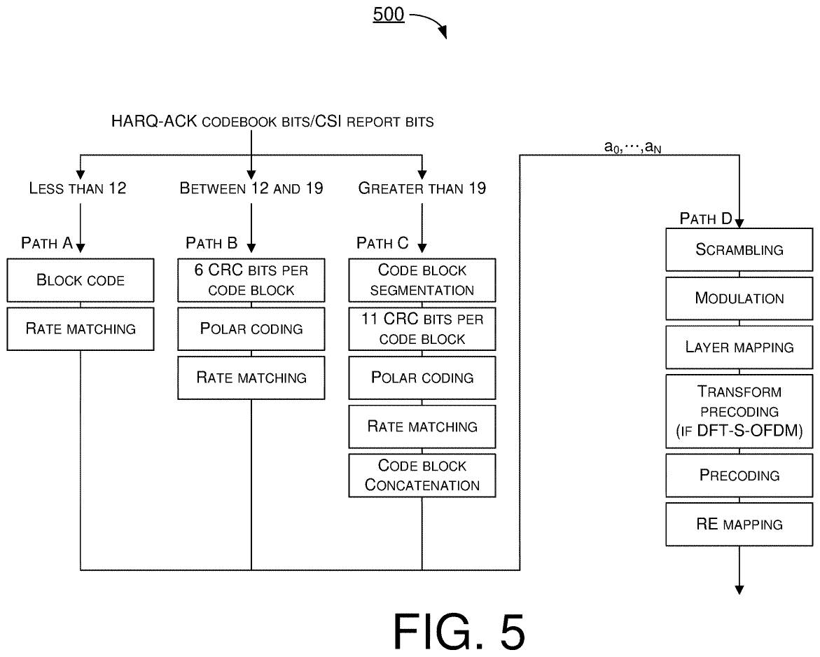

FIG. 5 illustrates an example scenario 500 under schemes in accordance with implementations of the present disclosure. For example, when the number of HARQ-ACK codebook bits or the number of CSI report bits is less than 12, the coding proceeds along path A which includes processes of: block code and rate matching. When the number of HARQ-ACK codebook bits or the number of CSI report bits is between 12 and 19, the coding proceeds along path B which includes processes of: 6 cyclic redundancy check (CRC) bits per code block, polar coding and rate matching. When the number of HARQ-ACK codebook bits or the number of CSI report bits is greater than 19, the coding proceeds along path C which includes processes of: code block segmentation, 11 CRC bits per code block, polar coding, rate matching and code block concatenation.

Further, after processes of each path, a₀ to a_{N} bits are generated. a₀ to a_{N} bits then are proceeded along path D which includes processes of: scrambling, modulation, layer mapping, transformation precoding (if discrete Fourier Transform-spread OFDM (DFT-S-OFDM) is applied), precoding and RE mapping.

In some implementations, in an event that UCI is transmitted by a PUSCH without UL data, PUSCH resource allocation may be: (1) dynamically scheduled, which means that the network may schedule DCI to provide scheduling information (e.g., time/frequency resource, transmission scheme, etc.) for PUSCH resource allocation; or (2) configured-like scheduled, which means that the network node may configure a set of scheduling information for PUSCH resource allocation by UE-specific RRC signaling and schedule DCI to indicate which set of scheduling information is selected for HARQ-ACK.

In some implementations, in an event that UCI is transmitted by a PUSCH with UL data, the UE apply configuration(s) (e.g., modulation, MIMO layer number and UL power control) of the UL data to the UCI on the same PUSCH. Code rate of the UCI may be different from code rate of UL data and may be indicated by corresponding DCI. For example, in some network scenarios, the UCI is not retransmitted, which requires the UCI transmission to be more robust. Therefore, the code rate of UCI is low (e.g., lower than the code rate of UL data).

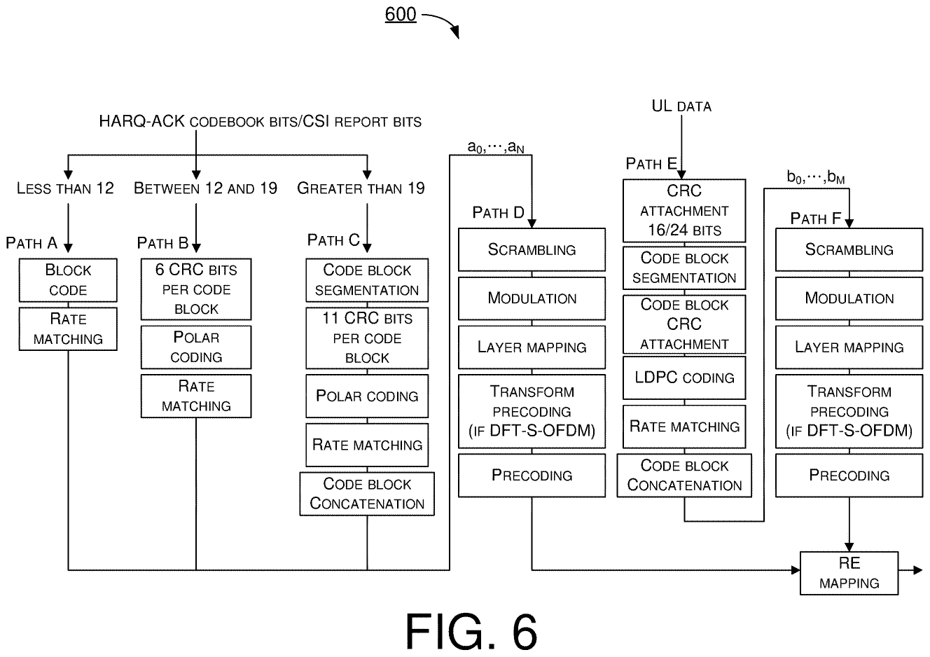

In some implementations, in an event that UCI is transmitted by a PUSCH with UL data, the UCI and the UL data may be multiplexed in RE-level. FIG. 6 illustrates an example scenario 600 under schemes in accordance with implementations of the present disclosure. For example, when the number of HARQ-ACK codebook bits or the number of CSI report bits is less than 12, the coding proceeds along path A block code and rate matching. When the number of HARQ-ACK codebook bits or the number of CSI report bits is between 12 and 19, the coding proceeds along path B which includes processes of: 6 CRC bits per code block, polar coding and rate matching. When the number of HARQ-ACK codebook bits or the number of CSI report bits is greater than 19, the coding proceeds along path C which includes processes of: code block segmentation, 11 CRC bits per code block, polar coding, rate matching and code block concatenation.

Further, after processes of each path, a₀ to a_{N} bits are generated. a₀ to a_{N} bits then are proceeded along path D which includes processes of: scrambling, modulation, layer mapping, transformation precoding (if DFT-S-OFDM is applied), precoding and RE mapping.

In addition, regarding the UL data, the coding proceeds along path E which includes processes of: CRC attachment 16/24 bits, code block segmentation, code block CRC attachment, low-density parity-check code (LDPC) coding, rate matching and code block concatenation.

Further, after processes of path E, b₀ to b_{M} bits are generated. b₀ to b_{M} then are proceeded along path F which includes processes of: scrambling, modulation, layer mapping, transformation precoding (if DFT-S-OFDM is applied), precoding and RE mapping.

In some cases, RE number for HARQ-ACK transmission is determined by the following equation:

N_{RE,HARQ}=N_{HARQ}/(Q×CR_{HARQ}×L)
where
N_{HARQ}: bit number of HARQ-ACK transmission, which is indicated by the network node in DCI;
Q: modulation order; baseline: (1) same as the UL data (if present); or (2) different from the UL data, and additional signaling on modulation order is indicated by the DCI;
CR_{HARQ}: target code rate; may be different from the UL data;
L: layer number; baseline: (1) same as UL DATA (if present); or (2) different from the UL data, and additional signaling on layer number is indicated by the DCI.

In some cases, RE number for UL data transmission is determined by the following equation:

$${N}_{info} = ( {N}_{RE} - {N}_{RE , HARQ} ) \times Q \times {CR}_{DATA} \times L$$

$${N}_{RE} = {N}_{PRB} \times {N}_{RE}^{′}$$

$${N}_{RE}^{′} = 12 \times {N}_{symb}^{sh} - {N}_{DMRS}^{PRB} - {N}_{oh}^{PRB}$$

In some cases, HARQ ACK bits and UL data bits may not be modulated as same symbol. If N_{coded, HARQ} mod Q≠0, M zero padding bits are added so that (N_{coded, HARQ}+M) mod Q=0, where M<Q.

Following table shows some examples of layer mapping:

| Number | |
|---|---|
| of | |
| Layer | Codeword to layer mapping |
| | $i = 0 , 1 , … , {M}_{sym}^{layeτ}$ |
| | $d = {d}_{0}^{HARQ} , … , {d}_{N - 1}^{HARQ} , {d}_{0}^{DATA} , … , {d}_{M - 1}^{DATA} , {M}_{symbol} = N + M$ |
| 1 | ${x}^{( 0 )} ( i ) = d ( i ) {M}_{sym}^{layer} = {M}_{symbol}$ |
| 2 | x⁽⁰⁾(i) = d(2i) |
| | ${x}^{( 1 )} ( i ) = d ( 2 i + 1 ) {M}_{sym}^{layer} = {M}_{symbol} / 2$ |
| 3 | x⁽⁰⁾(i) = d(3i) |
| | x⁽¹⁾(i) = d(3i + 1) |
| | ${x}^{( 2 )} ( i ) = d ( 3 i + 2 ) {M}_{sym}^{layer} = {M}_{symbol} / 3$ |
| 4 | x⁽⁰⁾(i) = d(4i) |
| | x⁽¹⁾(i) = d(4i + 1) |
| | x⁽²⁾(i) = d(4i + 2) |
| | ${x}^{( 3 )} ( i ) = d ( 4 i + 3 ) {M}_{sym}^{layer} = {M}_{symbol} / 4$ |

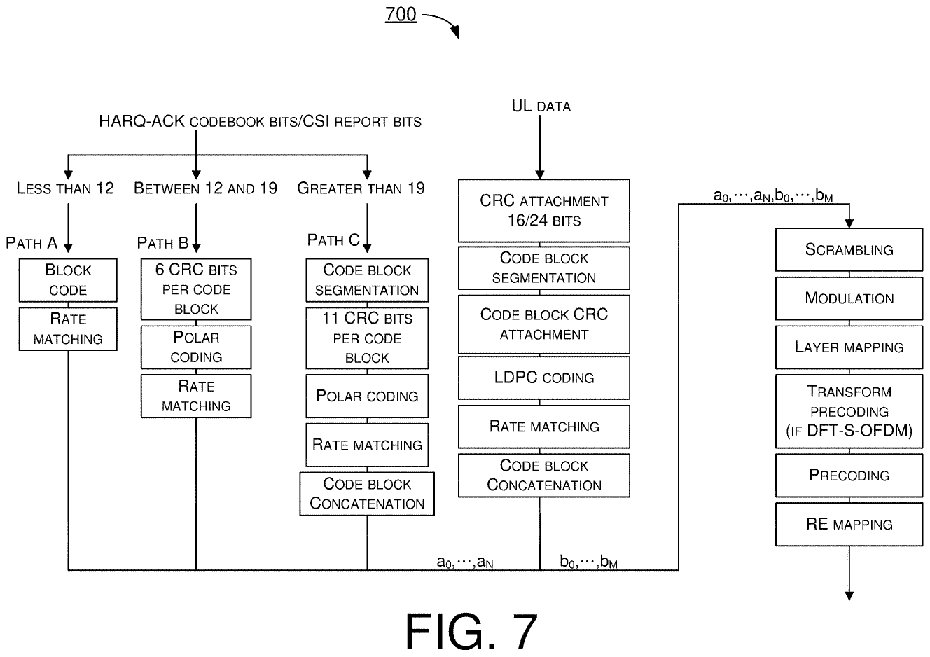

In some implementations, in an event that UCI is transmitted by a PUSCH with UL data, the UCI and the UL data may be multiplexed in bit-level. FIG. 7 illustrates an example scenario 700 under schemes in accordance with implementations of the present disclosure. For example, when the number of HARQ-ACK codebook bits or the number of CSI report bits is less than 12, the coding proceeds along path A which includes processes of: block code and rate matching. When the number of HARQ-ACK codebook bits or the number of CSI report bits is between 12 and 19, the coding proceeds along path B which includes processes of: 6 CRC bits per code block, polar coding and rate matching. When the number of HARQ-ACK codebook bits or the number of CSI report bits is greater than 19, the coding proceeds along path C which includes processes of: code block segmentation, 11 CRC bits per code block, polar coding, rate matching and code block concatenation.

Regarding the UL data, the coding proceeds along path D which includes processes of: CRC attachment 16/2 bits, code block segmentation, code block CRC attachment, LDPC coding, rate matching and code block concatenation. Then, the generated bits a₀ to a_{N} of path A, B or C is combined with the generated bits b₀ to b_{M} of path D. Regarding the combined bits a₀ to a_{N} and b₀ to b_{M}, the coding proceeds along path E. RE mapping is performed for result of path E which includes processes of: scrambling, modulation, layer mapping, transformation precoding (if DFT-S-OFDM is applied), precoding and RE mapping.

In some cases, coded bit number for HARQ-ACK transmission is determined by the following equation:

N_{HARQ, Coded}=N_{HARQ, Info}/CR_{HARQ}
where
N_{HARQ, Info}: bit number of HARQ-ACK transmission, which may be indicated by the network node in the DCI;
CR_{HARQ}: target code rate; may be different from UL data (e.g., lower code rate for HARQ-ACK transmission);
Baseline: modulation order (Q) and MIMO layer number (L) are: (1) same as for the UL data; or (2) different from the UL data, and additional information needs to be signaled to the UE by the DCI.

In some cases, coded bit number for UL data is determined by the following equation:

$${N}_{DATA , Info} = ( {N}_{RE} \times Q \times L - {N}_{HARQ , Coded} ) \times {CR}_{DATA}$$

$${N}_{RE} = {N}_{PRB} \times {N}_{RE}^{′}$$

$${N}_{RE}^{′} = 12 \times {N}_{symb}^{sh} - {N}_{DMRS}^{PRB} - {N}_{oh}^{PRB}$$

Following table shows some examples of layer mapping:

| | Codeword to layer mapping |
|---|---|
| Number of Layer | $i = 0 , 1 , … , {M}_{sym}^{layer}$ |
| 1 | ${x}^{( 0 )} ( i ) = d ( i ) {M}_{sym}^{layer} = {M}_{symbol}$ |
| 2 | x⁽⁰⁾(i) = d(2i) |
| | ${x}^{( 1 )} ( i ) = d ( 2 i + 1 ) {M}_{sym}^{layer} = {M}_{symbol} / 2$ |
| 3 | x⁽⁰⁾(i) = d(31) |
| | x⁽¹⁾(i) = d(3i + 1) |
| | ${x}^{( 2 )} ( i ) = d ( 3 i + 2 ) {M}_{sym}^{layer} = {M}_{symbol} / 3$ |
| 4 | x⁽⁰⁾(i) = d(4i) |
| | x⁽¹⁾(i) = d(4i + 1) |
| | x⁽²⁾(i) = d(4i + 2) |
| | ${x}^{( 3 )} ( i ) = d ( 4 i + 3 ) {M}_{sym}^{layer} = {M}_{symbol} / 4$ |

It should be noted that, regarding the mentioned paths, the details of the processes may be referred to 3rd generation partnership project (3GPP) specifications.

In some implementations, the DCI indicating a PUSCH used for UCI may include at least one of the following fields: (1) HARQ-ACK group index indicating which HARQ-ACK group may be feedback; (2) payload size of HARQ-ACK indicating bit number of HARQ-ACK codebook; (3) UCI code rate indicator for adjusting code rate of UCI; (4) CSI report type indicating CSI-RS based report or DMRS-based report; and (5) UCI type indicator indicating whether HARQ-ACK codebook and/or CSI report is included in PUSCH.

For example, field of HARQ-ACK group index is 1 bit where ‘0’ represents 1^{st} HARQ-ACK group and ‘1’ represents 2^{nd} HARQ-ACK group. Filed of CSI report type is 1 bit where ‘0’ represents CSI-RS based report and ‘1’ represents DMRS-based report. Filed of UCI type indicator is 3 bits where: (1) ‘000’ represents UL-SCH only; (2) ‘001’ represents HARQ-ACK codebook only; (3) ‘010’ represents CSI report only; (4) ‘011’ represents UL-SCH and HARQ-ACK codebook; (5) ‘100’ represents UL-SCH and CSI report; (6) ‘101’ HARQ-ACK codebook and CSI report; (7) ‘110’ represents UL-SCH, HARQ-ACK codebook and CSI report; and (8) ‘111’ represents reserved status.

### Illustrative Implementations

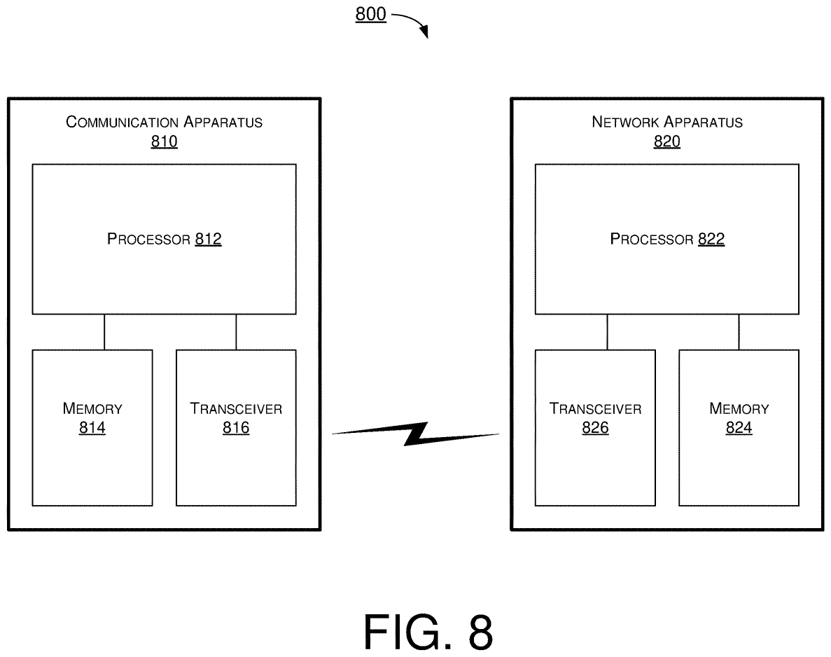

FIG. 8 illustrates an example communication system 800 having an example communication apparatus 810 and an example network apparatus 820 in accordance with an implementation of the present disclosure. Each of communication apparatus 810 and network apparatus 820 may perform various functions to implement schemes, techniques, processes and methods described herein pertaining to UCI transmission with respect to UE and network apparatus in mobile communications, including scenarios/schemes described above as well as processes 900 and 1000 described below.

Communication apparatus 810 may be a part of an electronic apparatus, which may be a UE such as a portable or mobile apparatus, a wearable apparatus, a wireless communication apparatus or a computing apparatus. For instance, communication apparatus 810 may be implemented in a smartphone, a smartwatch, a personal digital assistant, a digital camera, or a computing equipment such as a tablet computer, a laptop computer or a notebook computer. Communication apparatus 810 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 810 may be implemented in a smart thermostat, a smart fridge, a smart door lock, a wireless speaker or a home control center. Alternatively, communication apparatus 810 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 810 may include at least some of those components shown in FIG. 8 such as a processor 812, for example. Communication apparatus 810 may further include one or more other components not pertinent to the proposed scheme of the present disclosure (e.g., internal power supply, display device and/or user interface device), and, thus, such component(s) of communication apparatus 810 are neither shown in FIG. 8 nor described below in the interest of simplicity and brevity.

Network apparatus 820 may be a part of a network apparatus, which may be a network node such as a satellite, a base station, a small cell, a router or a gateway. For instance, network apparatus 820 may be implemented in an eNodeB in an LTE network, in a gNB in a 5G/NR, IoT, NB-IoT or IIoT network or in a satellite or base station in a 6G network. Alternatively, network apparatus 820 may be implemented in the form of one or more IC chips such as, for example and without limitation, one or more single-core processors, one or more multi-core processors, or one or more RISC or CISC processors. Network apparatus 820 may include at least some of those components shown in FIG. 8 such as a processor 822, for example. Network apparatus 820 may further include one or more other components not pertinent to the proposed scheme of the present disclosure (e.g., internal power supply, display device and/or user interface device), and, thus, such component(s) of network apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks including UCI transmission in a device (e.g., as represented by communication apparatus 810) and a network (e.g., as represented by network apparatus 820) in accordance with various implementations of the present disclosure.

In some implementations, communication apparatus 810 may also include a transceiver 816 coupled to processor 812 and capable of wirelessly transmitting and receiving data. In other words, processor 812 may transceive the data such as configuration, message, signal, information, indicator, etc. via transceiver 816. In some implementations, communication apparatus 810 may further include a memory 814 coupled to processor 812 and capable of being accessed by processor 812 and storing data therein. In some implementations, network apparatus 820 may also include a transceiver 826 coupled to processor 822 and capable of wirelessly transmitting and receiving data. In other words, processor 822 may transceive the data such as configuration, message, signal, information, indicator, etc. via transceiver 826. In some implementations, network apparatus 820 may further include a memory 824 coupled to processor 822 and capable of being accessed by processor 822 and storing data therein. Accordingly, communication apparatus 810 and network apparatus 820 may wirelessly communicate with each other via transceiver 816 and transceiver 826, respectively. To aid better understanding, the following description of the operations, functionalities and capabilities of each of communication apparatus 810 and network apparatus 820 is provided in the context of a mobile communication environment in which communication apparatus 810 is implemented in or as a communication apparatus or a UE and network apparatus 820 is implemented in or as a network node of a communication network.

In some implementations, each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

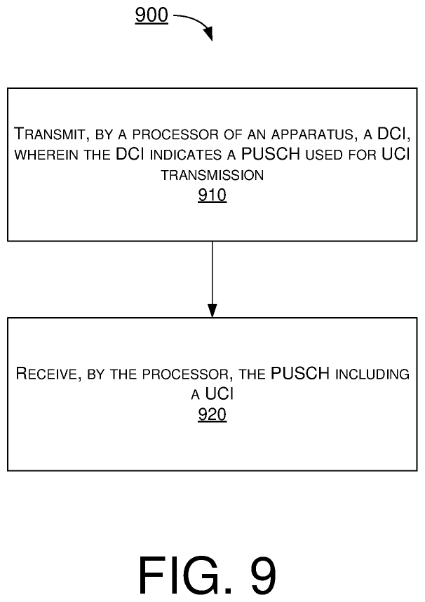

FIG. 9 illustrates an example process 900 in accordance with an implementation of the present disclosure. Process 900 may be an example implementation of above scenarios/schemes, whether partially or completely, with respect to UCI transmission of the present disclosure. Process 900 may represent an aspect of implementation of features of network apparatus 820. Process 900 may include one or more operations, actions, or functions as illustrated by one or more of blocks 910 to 920. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by network apparatus 820 or any suitable network device or machine type devices. Solely for illustrative purposes and without limitation, process 900 is described below in the context of network apparatus 820. Process 900 may begin at block 910.

At block 910, process 900 may involve processor 822 of network apparatus 820 transmitting a DCI. The DCI may indicate a PUSCH used for UCI transmission. Process 900 may proceed from block 910 to block 920.

At block 920, process 900 may involve processor 822 of network apparatus 820 receiving the PUSCH including a UCI.

In some implementations, the UCI may include at least one of a HARQ-ACK codebook and a CSI report.

In some implementations, a payload size associated with the UCI may be indicated by the DCI or a higher layer signaling.

In some implementations, the DCI may indicate that the PUSCH carries an UL data or excludes any UL data.

In some implementations, in an event that the PUSCH carries the UL data, process 900 may involve processor 822 of network apparatus 820 decoding the UCI and the UL data of the PUSCH separately.

In some implementations, in an event that the PUSCH carries the UL data, the UCI and the UL data may be mapped to a plurality of REs of the PUSCH from a specific RE of the PUSCH. The UCI and the UL data may be mapped in order. The plurality of REs may exclude at least one RE for DMRS. The specific RE may be within a first available OFDM symbol and have lowest RE index.

In some implementations, the UCI may include a HARQ-ACK codebook and a CSI report. The HARQ-ACK codebook and the CSI report may be mapped in order.

In some implementations, in an event that the PUSCH excludes any UL data, the UCI may be mapped to a plurality of REs of the PUSCH from a specific RE of the PUSCH. The plurality of REs may exclude at least one RE for DMRS. The specific RE may be within a first available OFDM symbol and have lowest RE index.

In some implementations, the UCI may include a HARQ-ACK codebook and a CSI report. The HARQ-ACK codebook and the CSI report may be mapped in order.

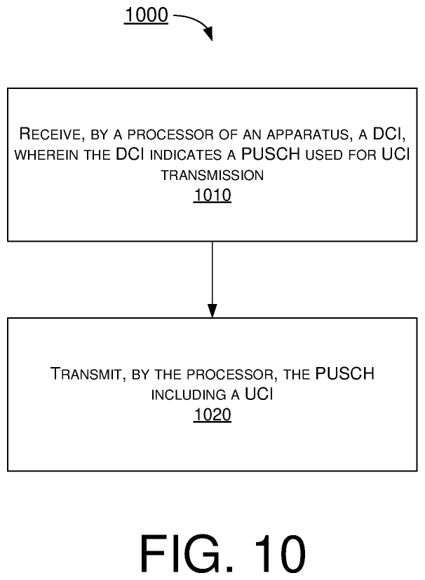

FIG. 10 illustrates an example process 1000 in accordance with an implementation of the present disclosure. Process 1000 may be an example implementation of above scenarios/schemes, whether partially or completely, with respect to UCI transmission of the present disclosure. Process 1000 may represent an aspect of implementation of features of communication apparatus 810. Process 1000 may include one or more operations, actions, or functions as illustrated by one or more of blocks 1010 to 1020. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by communication apparatus 810 or any suitable UE or machine type devices. Solely for illustrative purposes and without limitation, process 1000 is described below in the context of communication apparatus 810. Process 1000 may begin at block 1010.

At block 1010, process 1000 may involve processor 812 of communication apparatus 810 receiving a DCI. The DCI may indicate a PUSCH used for UCI transmission. Process 1000 may proceed from block 1010 to block 1020.

At block 1020, process 1000 may involve processor 812 of communication apparatus 810 transmitting the PUSCH including a UCI.

In some implementations, the UCI may include at least one of a HARQ-ACK codebook and a CSI report.

In some implementations, a payload size associated with the UCI may be indicated by the DCI or a higher layer signaling.

In some implementations, the DCI may indicate that the PUSCH carries an UL data or excludes any UL data.

In some implementations, in an event that the PUSCH carries the UL data, process 1000 may involve processor 812 of communication apparatus 810 encoding the UCI and the UL data of the PUSCH separately.

In some implementations, in an event that the PUSCH carries the UL data, process 1000 may involve processor 812 of communication apparatus 810 mapping the UCI and the UL data to a plurality of REs of the PUSCH from a specific RE of the PUSCH. The UCI and the UL data may be mapped in order. The plurality of REs may exclude at least one RE for DMRS. The specific RE may be within a first available OFDM symbol and have lowest RE index.

In some implementations, the UCI may include a HARQ-ACK codebook and a CSI report. The HARQ-ACK codebook and the CSI report may be mapped in order.

In some implementations, in an event that the PUSCH excludes any UL data, process 1000 may involve processor 812 of communication apparatus 810 mapping the UCI to a plurality of REs of the PUSCH from a specific RE of the PUSCH. The plurality of REs may exclude at least one RE for DMRS. The RE may be within a first available OFDM symbol and have lowest RE index.

In some implementations, the UCI includes a HARQ-ACK codebook and a CSI report, and the HARQ-ACK codebook and a CSI report are mapped in order.

In some implementations, the DCI may include a HARQ-ACK group index associated with a HARQ-ACK codebook including at least one HARQ-ACK information. Process 1000 may involve processor 812 of communication apparatus 810 transmitting the HARQ-ACK codebook associated with the HARQ-ACK group index in the UCI.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus, a downlink control information (DCI), wherein the DCI indicates a physical uplink shared channel (PUSCH) used for uplink control information (UCI) transmission; and
receiving, by the processor, the PUSCH including a UCI.

2. The method of claim 1, wherein the UCI includes at least one of a hybrid automatic repeat request-acknowledgment (HARQ-ACK) codebook and a channel state information (CSI) report.

3. The method of claim 1, wherein a payload size associated with the UCI is indicated by the DCI or a higher layer signaling.

4. The method of claim 2, wherein the DCI indicates that the PUSCH carries an uplink (UL) data or excludes any UL data.

5. The method of claim 4, wherein in an event that the PUSCH carries the UL data, the method further comprises:
decoding, by the processor, the UCI and the UL data of the PUSCH separately.

6. The method of claim 4, wherein in an event that the PUSCH carries the UL data, the UCI and the UL data are mapped to a plurality of resource elements (REs) of the PUSCH from a specific RE of the PUSCH, the UCI and the UL data are mapped in order, the plurality of REs excludes at least one RE for demodulation reference signal (DMRS), and the specific RE is within a first available orthogonal frequency-division multiplexing (OFDM) symbol and has lowest RE index.

7. The method of claim 6, wherein the UCI includes a HARQ-ACK codebook and a CSI report, and the HARQ-ACK codebook and the CSI report are mapped in order.

8. The method of claim 4, wherein in an event that the PUSCH excludes any UL data, the UCI is mapped to a plurality of resource elements (REs) of the PUSCH from a specific RE of the PUSCH, the plurality of REs excludes at least one RE for demodulation reference signal (DMRS), and the specific RE is within a first available orthogonal frequency-division multiplexing (OFDM) symbol and has lowest RE index.

9. The method of claim 8, wherein the UCI includes a HARQ-ACK codebook and a CSI report, and the HARQ-ACK codebook and the CSI report are mapped in order.

10. A method, comprising:
receiving, by a processor of an apparatus, a downlink control information (DCI), wherein the DCI indicates a physical uplink shared channel (PUSCH) used for uplink control information (UCI) transmission; and
transmitting, by the processor, the PUSCH including a UCI.

11. The method of claim 10, wherein the UCI includes at least one of a hybrid automatic repeat request-acknowledgment (HARQ-ACK) codebook and a channel state information (CSI) report.

12. The method of claim 10, wherein a payload size associated with the UCI is indicated by the DCI or a higher layer signaling.

13. The method of claim 11, wherein the DCI indicates that the PUSCH carries an uplink (UL) data or excludes any UL data.

14. The method of claim 13 wherein in an event that the PUSCH carries the UL data, the method further comprises:
encoding, by the processor, the UCI and the UL data of the PUSCH separately.

15. The method of claim 13, wherein in an event that the PUSCH carries the UL data, the method further comprises:
mapping, by the processor, the UCI and the UL data to a plurality of resource elements (REs) of the PUSCH from a specific RE of the PUSCH, wherein the UCI and the UL data are mapped in order, the plurality of REs excludes at least one RE for demodulation reference signal (DMRS), and the specific RE is within a first available orthogonal frequency-division multiplexing (OFDM) symbol and has lowest RE index.

16. The method of claim 15, wherein the UCI includes a HARQ-ACK codebook and a CSI report, and the HARQ-ACK codebook and the CSI report are mapped in order.

17. The method of claim 13, wherein in an event that the PUSCH excludes any UL data, the method further comprises:
mapping, by the processor, the UCI to a plurality of resource elements (REs) of the PUSCH from a specific RE of the PUSCH, wherein the plurality of REs excludes at least one RE for demodulation reference signal (DMRS), and the RE is within a first available orthogonal frequency-division multiplexing (OFDM) symbol and has lowest RE index.

18. The method of claim 17, wherein the UCI includes a HARQ-ACK codebook and a CSI report, and the HARQ-ACK codebook and the CSI report are mapped in order.

19. The method of claim 10, wherein the DCI includes a hybrid automatic repeat request-acknowledgment (HARQ-ACK) group index associated with a HARQ-ACK codebook including at least one HARQ-ACK information, and the method further comprises:
transmitting, by the processor, the HARQ-ACK codebook associated with the HARQ-ACK group index in the UCI.

20. An apparatus, comprising:
a transceiver which, during operation, wirelessly communicates with a wireless network; and
a processor communicatively coupled to the transceiver such that, during operation, the processor performs operations comprising:
transmitting, via the transceiver, a downlink control information (DCI), wherein the DCI indicates a physical uplink shared channel (PUSCH) used for uplink control information (UCI) transmission; and
receiving, via the transceiver, the PUSCH including a UCI.
